(19) United States
(12) Patent Application Publication
(10) Pub. No.: US 2026/0203367 A1
(43) Pub. Date: Jul. 16, 2026

(54) PARALLEL EXECUTION OF MATRIX MULTIPLICATIONS AND VECTOR OPERATIONS IN AN AI ENGINE

(71) Applicant: XILINX, INC., San Jose, CA (US)

(72) Inventors: Juan J. NOGUERA SERRA, San Jose, CA (US); Baris OZGUL, Dublin (IE); Francisco BARAT QUESADA, Erembodegem (BE); Javier CABEZAS RODRIGUEZ, Austin, TX (US); Stephan MUNZ, Dublin (IE)

(21) Appl. No.: 19/019,418

(22) Filed: Jan. 13, 2025

(51) Int. Cl. G06F 17/16; G06F 9/38

(52) U.S. Cl. CPC G06F 17/16; G06F 9/38

(57) ABSTRACT

Embodiments herein describe an artificial intelligence (AI) engine including first functional circuitry configured to perform a first set of instructions that include a matrix operation and second functional circuitry configured to perform a second set of instructions that include a vector operation, where the second set of instructions are concurrently performed with the first set of instructions. The first set of instructions include instructions for an operation to perform based on two or more matrices and the second set of instructions include instructions for an operation to perform based on one or more vectors. The first set of instructions include instructions for an operation to perform based on a matrix and a vector and the second set of instructions include instructions for an operation to perform based on one or more vectors.

### TECHNICAL FIELD

Examples of the present disclosure generally relate to artificial intelligence (AI) engines, and, in particular, to parallel execution of matrix multiplications and vector operations in an AI engine.

### BACKGROUND

In the field of artificial intelligence (AI) and machine learning (ML), the efficiency and performance of computational tasks is important for advancing algorithmic capabilities and real-time data processing. AI engines have evolved to address the demanding requirements of these applications by executing both matrix x matrix and vector x vector instructions. However, the implementation of these operations has often involved dedicated functional units, leading to limitations in flexibility and overall system performance.

### SUMMARY

One embodiment described herein is an artificial intelligence (AI) engine including first functional circuitry configured to perform a first set of instructions that include a matrix operation and second functional circuitry configured to perform a second set of instructions that include a vector operation, where the second set of instructions are concurrently performed with the first set of instructions. The first set of instructions include instructions for an operation to perform based on two or more matrices and the second set of instructions include instructions for an operation to perform based on one or more vectors. The first set of instructions include instructions for an operation to perform based on a matrix and a vector and the second set of instructions include instructions for an operation to perform based on one or more vectors.

One embodiment described herein is a method including performing a first set of instructions using first functional circuitry, where performing the first set of instructions includes performing a matrix operation and performing a second set of instructions using second functional circuitry, where performing the second set of instructions includes performing a vector operation, and where the second set of instructions are concurrently performed with the first set of instructions in an artificial intelligence (AI) engine.

One embodiment described herein is a processor including one or more artificial intelligence (AI) engines, each AI engine configured to include first functional circuitry configured to perform a first set of instructions that include a matrix operation and second functional circuitry configured to perform a second set of instructions that include a vector operation, where the second set of instructions are concurrently performed with the first set of instructions

### BRIEF DESCRIPTION OF DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 illustrates an artificial intelligence (AI) engine including a single functional unit.

FIG. 2 illustrates an AI engine including two functional units for concurrently performing matrix x matrix (or vector x matrix) and vector x vector operations, according to an example.

FIG. 3 is a block diagram of an accelerator unit (AU) configured to execute workloads for applications running on a processing system, according to an example.

FIG. 4 illustrates a method for using two functional units for concurrently performing matrix x matrix (or vector x matrix) and vector x vector operations, according to an example.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the embodiments herein or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

Matrix and vector operations are foundational to artificial intelligence (AI) and machine learning (ML), providing the mathematical framework for processing and transforming data. These operations facilitate the representation of complex relationships and transformations within neural networks, optimization algorithms, and data analysis techniques.

Matrix multiplication involves two matrices that are multiplied together to produce a third matrix. To multiply two matrices, the number of columns in the first matrix equals the number of rows in the second matrix. Datasets in ML are often represented as matrices, where rows correspond to individual samples (data points) and columns correspond to features (variables). In neural networks, the input to each layer is represented as a matrix, and the weights associated with connections between layers are also represented as matrices. During forward propagation, the input matrix is multiplied by the weight matrix to compute the outputs for the layer. This process allows the network to learn complex functions through the multiplication of matrices across multiple layers. In convolutional neural networks (CNNs), matrix operations are used for convolutions, where a filter (kernel) matrix is applied to input data to extract features.

Vector multiplication can refer to several types of operations, including the dot product and the cross product. The dot product of two vectors produces a scalar (single number). The dot product measures the cosine of the angle between the two vectors and is used to determine orthogonality, similarity, and projections. The dot product is used in ML algorithms to measure the similarity between feature vectors. The dot product quantifies how closely aligned two vectors are, which is fundamental in algorithms like support vector machines and k-nearest neighbors. The cross product of two vectors produces a new vector that is perpendicular to both vectors. Vector operations are prevalent in AI/ML for computing weighted sums.

Another multiplication is the Hadamard product, also referred to as the element-wise product, which is an operation of two matrices of the same dimensions. Stated differently, it is an element-wise multiplication of each element in two vectors. This is the most used operation in the vector unit. The Hadamard product is distinct from matrix multiplication (dot product), which involves summing the products of elements across rows and columns. As such, the dot-product is used more in the vector x matrix operations (on a per column basis).

Matrix and vector operations can be performed by a functional unit. A functional unit is a component of a computer’s architecture that performs a specific operation, such as addition, subtraction, multiplication, or more complex functions like matrix multiplication or vector operations. When a functional unit is described as performing either matrix x matrix or vector x vector operations in every cycle, it means that it can start every clock cycle and it usually takes more than one clock cycle to execute. A dedicated functional unit for matrix multiplication can handle multiple input streams simultaneously, leveraging parallelism to compute the resulting matrix efficiently. A functional unit dedicated to vector operations can efficiently handle tasks like computing similarity scores between feature vectors or performing transformations on input data.

As such, matrix and vector operations are consequential for AI/ML methodologies, enabling efficient data manipulation and transformation. By utilizing these mathematical frameworks, ML models can learn from data, make predictions, and optimize their performance across a wide array of applications. However, a single functional unit performs either a matrix x matrix operation (matrix-matrix) operation or a vector x vector (vector-vector) operation every cycle. The limitation of a single functional unit capable of executing either matrix multiplication or vector operations every cycle but not both poses challenges to computational efficiency and flexibility. Restricting the ability to execute these operations concurrently hinders the system’s ability to fully utilize its computational resources, leading to bottlenecks when workloads demand simultaneous execution of these tasks.

One issue lies in the trade-off between throughput and operation diversity. For example, many workloads involve a blend of dense matrix multiplications, common in neural network training, and vector operations, beneficial for iterative algorithms. When only one of these operations can be performed at a time, tasks that can otherwise overlap in execution instead wait, creating idle cycles for one type of operation while the other is being processed. This serialization of tasks reduces overall performance and undermines the potential benefits of high-performance computing systems. Furthermore, the limitation can complicate workload scheduling and increase latency. For applications involving interleaved matrix x matrix operations (or vector x matrix operations) and vector x vector operations, the inability to perform them concurrently may force, e.g., developers to re-architect software to accommodate the hardware restriction, potentially introducing inefficiencies or complexity into the codebase. The lack of flexibility in handling mixed workloads also reduces the system’s scalability, especially as computational demands continue to grow in data-driven applications.

In view of such challenges, the example embodiments present a method and system for enabling an AI engine to concurrently or simultaneously perform, using a first functional unit and a second functional unit, matrix x matrix operations (or vector x matrix operations) and vector x vector operations in every cycle. By utilizing an AI engine core that performs matrix x matrix (or vector x matrix) and vector x vector instructions concurrently or simultaneously, using two functional units, significant improvements can be achieved in terms of parallelism, resource optimization, and reduced latency. This approach allows for optimizations tailored to each operation type, ensuring that the AI engine can efficiently handle complex workflows that combine both matrix and vector computations. Consequently, such an approach with dual functional units not only enhances the throughput and responsiveness of AI applications but also provides a modular approach to system integration, facilitating the development of scalable and versatile AI solutions.

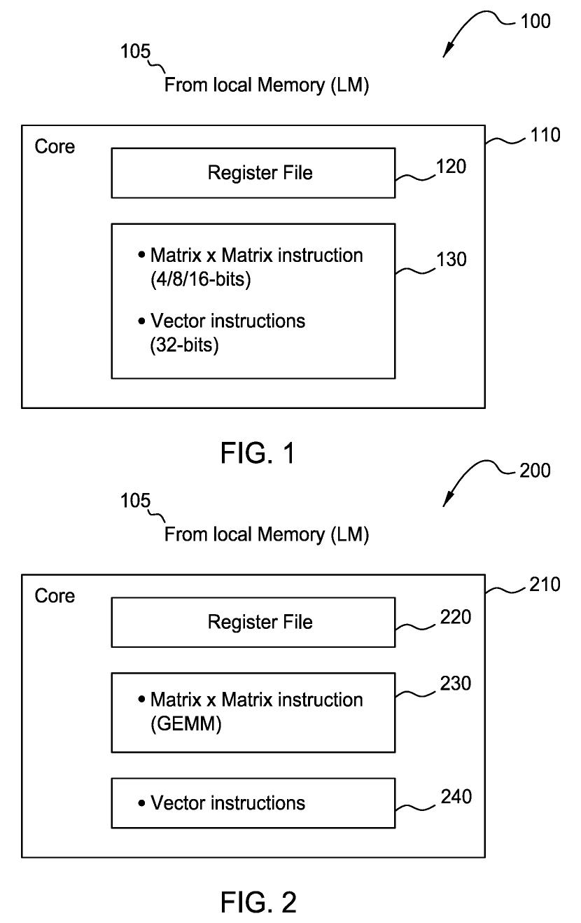

FIG. 1 illustrates an artificial intelligence (AI) engine including a single functional unit.

The system 100 includes an AI engine core 110 that includes a register file 120 and a functional unit 130. The functional circuitry may also be referred to as functional circuitry or circuitry. The register file 120 stores data from a local memory 105. The functional unit 130 may perform either matrix x matrix (or matrix-matrix) or vector x vector (or vector-vector) operations.

The AI engine core 110 is a specialized processing unit or component within a computing architecture designed specifically for executing AI tasks. The AI engine core 110 is employed for various AI workloads, including ML, deep learning (DL), and data inference. The AI engine core 110 accelerates the execution of AI algorithms, particularly those involving large-scale data processing and complex mathematical computations, such as matrix multiplications and vector operations. The AI engine core 110 supports parallel processing capabilities, allowing it to execute multiple computations simultaneously. This is beneficial for handling the large datasets and complex calculations common in AI workloads.

The register file 120 is a small, fast storage area used to hold data temporarily during computation. The register file 120 is a valuable component in modern processors, including those designed for AI and ML tasks. The register file 120 consists of a collection of registers, which are small, high-speed storage locations within the central processing unit (CPU) or graphics processing unit (GPU) or the AI engine core 110. The registers are used to hold data that is frequently accessed or manipulated during processing, providing quicker access than other forms of memory (like random access memory (RAM) or cache). The primary purpose of the register file 120 is to facilitate fast data retrieval and storage for arithmetic and logical operations. By keeping frequently used values close to the processing units, the register file 120 helps reduce latency and improve overall processing speed.

During the execution of matrix x matrix and vector x vector operations, the register file 120 is valuable for storing intermediate results, coefficients, and temporary variables. This is particularly important in AI tasks involving deep learning, where numerous matrix multiplications and transformations occur.

However, the system 100 includes a single functional unit that performs either a matrix x matrix operation (matrix-matrix) operation or a vector x vector (vector-vector) operation in every cycle. The limitation of a single functional unit capable of executing either matrix multiplication or vector operations in every cycle but not both poses challenges to computational efficiency and flexibility.

FIG. 2 illustrates an AI engine including two functional units for concurrently performing matrix x matrix (or vector x matrix) and vector x vector operations, according to an example.

The system 200 includes an AI engine core 210 that includes a register file 220, a first functional unit 230, and a second functional unit 240. The AI engine or AI engine core 210 may be referred to as a tile or compute tile. The functional circuitry may also be referred to as functional circuitry or circuitry. The register file 220 stores data from the local memory 105. The first functional unit 230 may perform matrix x matrix (or matrix-matrix) operations and the second functional unit 240 may perform vector x vector (vector-vector) operations. The first functional unit 230 can operate concurrently with the second functional unit 240. The matrix-matrix instructions operate on data types that may be 4 bit, 8 bit or 16 bit length, whereas the vector-vector instructions operate on data types that may be 32 bit length. In one example, the data corresponding to the matrix-matrix instructions may have a first bit length and the data corresponding to the vector-vector instructions may have a second bit length, where the second bit length is typically greater than the first bit length. However, in other cases, the second bit length may be smaller than the first bit length.

In another example, the first functional unit 230 may perform vector x matrix (or vector-matrix) operations instead of matrix x matrix operations. In such case, the first functional unit 230 can operate concurrently with the second functional unit 240. The vector-matrix operations can support different operations, such as dot product, matrix-vector multiplication, or element-wise operations. The vector-matrix operation can refer to any mathematical or computational operation involving a vector and a matrix. For matrix-vector multiplication, a new vector is computed by combining the rows of a matrix with the entries of a vector. For element-wise multiplication, the corresponding elements of the vector and the matrix are operated on directly, where the vector and the matrix have compatible dimensions. For the dot product, the vector is multiplied with rows and columns of a matrix.

Incorporating two distinct functional units (the first functional unit 230 and the second functional unit 240) within the AI engine core 210, where one is dedicated to matrix × matrix operations (or vector x matrix operations) and the other to vector × vector operations, provides a versatile and efficient computational resource for diverse workloads. This dual-functional-unit architecture allows the AI engine core 210 to simultaneously process tasks used for each operation type, significantly boosting throughput and reducing idle time compared to architectures with a single functional unit performing either one task (matrix multiplication or matrix-vector multiplication) or the other task (vector operations).

The first functional unit 230, used for matrix operations such as matrix × matrix operations (e.g., multiplication of two or more matrices), vector x matrix operations (e.g., multiplication of a vector and a matrix), or matrix x scalar operations (e.g., multiplication of a matrix by a scalar), may focus on dense linear algebra computations, which are prevalent in ML tasks like training and inference for neural networks. These operations, such as multiplying large tensors, benefit from hardware features like high-dimensional systolic arrays or specialized dataflow architectures. The first functional unit 230 can use techniques like tiling and shared memory utilization to maximize parallelism and data reuse, ensuring optimal performance for large-scale matrix (or matrix-vector) computations.

The second functional unit 240, used for vector operations, may handle vector-specific tasks such as dot products, element-wise operations, and reductions. These tasks are common in optimization algorithms and certain aspects of neural network operations like vector normalization or feature extraction. By tailoring the second functional unit 240 for high-speed, low-dimensional operations, the AI engine core 210 can execute these computations with minimal latency, enabling fast and responsive performance for workloads involving frequent vector manipulations.

By integrating both functional units within the same or a single AI engine (i.e., the AI engine core 210), resource utilization is optimized, and task execution becomes more flexible. Workloads that demand a mix of matrix × matrix (or vector x matrix) and vector × vector operations, such as reinforcement learning (RL) algorithms, can distribute these tasks across the respective units without bottlenecks. Shared resources, such as memory and interconnects, further enhance performance by enabling efficient data exchange between the first functional unit 230 and the second functional unit 240. This approach accelerates computational workflows and reduces the energy footprint of executing complex AI tasks by minimizing redundant data movements and ensuring each functional unit operates at peak efficiency.

Stated differently, this architecture allows simultaneous processing of matrix × matrix (or vector x matrix) and vector × vector instructions, using the unique strengths of each functional unit. By enabling concurrent or simultaneous operations, the AI engine core 210 optimizes resource utilization and accelerates workloads with mixed computational requirements, such as neural network training and data analytics. One advantage of this dual-unit architecture lies in its ability to execute matrix × matrix (or vector x matrix) and vector × vector operations in parallel. When workloads involve both types of instructions, the AI engine core 210 can distribute them across the functional units, maximizing throughput and reducing overall execution time. Shared resources, such as high-bandwidth memory and interconnects, facilitate efficient data exchange between the functional units, ensuring seamless integration of results. This parallelism also allows for more dynamic workload scheduling, enabling the AI engine core 210 to adapt to varying task demands without sacrificing performance.

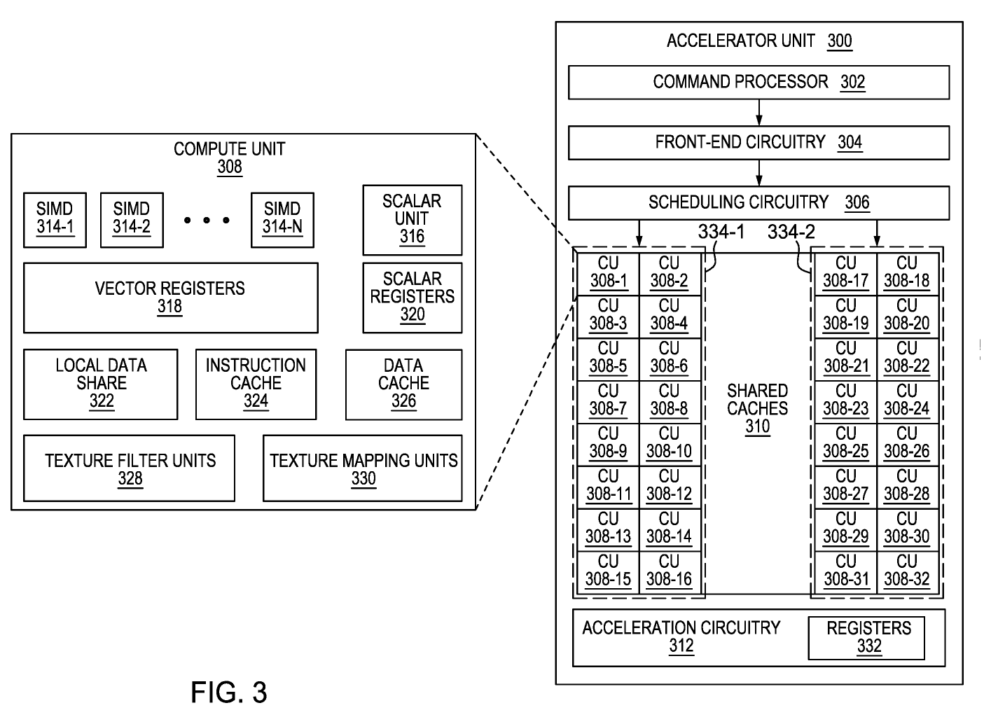

In one example, the first functional unit 230 may be a general matrix multiply (GEMM) unit. The GEMM unit is designed to perform matrix multiplication operations with high efficiency. This specialization allows it to exploit parallelism and optimize the use of memory bandwidth, which is beneficial for performance in large-scale computations. GEMM units often employ multiple processing cores and single instruction, multiple data (SIMD) instructions to perform multiple multiplications and additions simultaneously. This parallel processing capability significantly speeds up matrix operations compared to traditional CPU implementations. The architecture of GEMM units is optimized for memory access patterns that reduce latency and maximize throughput. GEMM units are commonly integrated into larger hardware systems, such as graphics processing units (GPUs), described in detail with reference to FIG. 3.

In one example, the second functional unit 240 may be, e.g., an arithmetic unit, a multiply-accumulate (MAC) unit, a load-store unit, a shuffling and permutation unit, a reduction unit, a comparison unit, a conversion unit, a bitwise logic unit, a vector condition code unit, or a vector streaming unit. Each type of functional unit is tailored for specific operations. For example, the arithmetic unit can perform arithmetic operations on vector data. The MAC unit can perform operations like dot products and matrix-vector multiplications. The load-store unit can facilitate data transfer between memory and vector registers. The reduction unit can aggregate vector elements into a single result. The comparison unit can compare vector elements. The conversion unit can convert between data types (e.g., integer to floating point). The bitwise logic unit can perform bit-level operations on vector data. The vector condition code unit can evaluate vector conditions and generate condition codes. The vector streaming unit can enable seamless vector streaming for real-time processing without explicit loading into registers.

The first functional unit 230 and the second functional unit 240 may have structural differences. Structural differences may relate to data organization and storage, computational granularity, interconnects and data flow, arithmetic complexity, and functional unit control logic. For example, the first functional unit 230 may handle 2D arrays of data (i.e., rows and columns), whereas the second functional unit 240 may handle 1D arrays of data. The first functional unit 230 may use more complex memory layouts, such as row-major and column-major ordering, whereas the second functional unit may use linear storage like contiguous memory or vector registers. The first functional unit 230 may use complex interconnects for cross-row and cross-column data sharing, whereas the second functional unit 240 may use simpler interconnects as data flows linearly through the pipeline. The first functional unit 230 may use single instruction multiple threads (SIMT) control logic, whereas the second functional unit 240 may use single instruction multiple data (SIMD) control logic. As such, the first functional unit 230 (i.e., matrix functional unit) may be structurally more complex that the second functional unit 240 (i.e., vector functional unit) due to the need for cross-row and cross-column interactions, more sophisticated data handling, and higher computational density.

In the AI engine core 210 where a GEMM unit is used for low-precision data units and a vector instruction unit focuses on higher bit-width precision arithmetic operations, the division of labor between these units provides an opportunity to improve both computational efficiency and power consumption. This architecture uses the strengths of low-precision arithmetic, which is prevalent in AI workloads, while reserving high-precision computations for tasks that genuinely need it. By dynamically allocating instructions based on precision needs, the system or architecture achieves a balance between performance and power efficiency.

Low-precision data types, such as INT8 or FP16, are commonly used in matrix-heavy AI operations like neural network training and inference, as they offer significant computational and memory bandwidth advantages without substantial loss of accuracy for many applications. The GEMM unit, optimized for such low-precision arithmetic operations, can execute matrix × matrix operations with high throughput and low power consumption. Its design minimizes energy per operation by reducing the switching activity and complexity associated with processing larger bit-widths (or bit-width precision arithmetic operations).

On the other hand, the vector instruction unit, used for higher bit-width precision such as FP32 or FP64, may handle tasks involving greater numerical accuracy, such as gradient computations, scientific simulations, or certain pre- and post-processing steps in AI workflows. In one example, by limiting high-precision computations to the vector unit, the AI engine avoids unnecessary power expenditure on operations that can tolerate lower precision. This selective use of resources ensures the system maintains accuracy where it is critical while optimizing energy use for the majority of tasks.

Since most instructions in AI workloads involve matrix × matrix operations, which are routed to the GEMM unit, substantial power savings can be achieved. The GEMM unit’s focus on low-precision arithmetic operations allows it to execute these operations at a fraction of the energy cost compared to a general-purpose high-precision unit. In one example, by offloading the few remaining high-precision tasks to the vector instruction unit, the AI engine core 210 avoids the inefficiencies of using a one-size-fits-all approach. This specialization not only improves power efficiency but also maximizes throughput, making it ideal for power-constrained environments with stringent energy budgets.

Thus, in one example, the precision of the vector unit is larger than that of the matrix unit for certain operands, e.g., INT8 vs INT32. However, this may not be the case for other operands, e.g., INT32 or FLOAT32). For example, the matrix unit operates on INT8 operands for efficient memory usage and high throughput, while the vector unit accumulates results in INT32 for enhanced precision and range. However, in other examples, the matrix precision may be larger. For example, when the matrix unit operates on FLOAT32, which provides a wider dynamic range. An example may include in machine learning training for forward and backward propagation in neural networks. In such case, FLOAT32 may be used for weight updates and gradient calculations. Thus, in mixed-precision systems, the choice of vector and matrix precision depends on balancing computational speed, energy efficiency, and application-specific accuracy requirements.

As such, the AI engine core 210 that performs both matrix x matrix (or vector x matrix) and vector x vector instructions presents numerous benefits, including versatility, enhanced performance, simplified architecture, resource optimization, advanced capabilities, and improved scalability. This dual functionality positions such AI engine cores as powerful components in modern AI systems, enabling more efficient, effective, and flexible computations across a wide range of applications. By accommodating the diverse and evolving needs of AI workloads, these cores can significantly enhance the performance and capability of AI and ML solutions.

The benefit of performing matrix-matrix (or vector x matrix) and vector-vector operations in one single AI engine using two functional units extends beyond just functionality, it also contributes significantly to efficient silicon utilization, a valuable factor in modern chip design. By integrating the ability to perform both matrix-matrix (or vector x matrix) and vector-vector operations within a single AI engine, the same data paths, register files, and memory controllers are reused, minimizing redundant hardware. The two functional units (e.g., one optimized for scalar/vector operations and the other for matrix operations) work in tandem, ensuring that no part of the silicon is idle during mixed workloads. Dedicated engines for matrix-only or vector-only (or vector-matrix) operations can result in unused silicon when workloads vary. A unified engine adapts dynamically, ensuring optimal use. A single AI engine with dual-functional capabilities uses fewer logic gates than separate engines, saving space that can be allocated to other components, such as memory or control logic. This design lowers the overall die size, reducing manufacturing costs and increasing yield during chip fabrication. Consolidating matrix, vector, and vector-matrix operations into a single AI engine ensures that performance per unit area is maximized. This enables higher computational throughput within the same silicon area and improved performance-to-cost ratios for AI accelerators. Also, using two functional units in a single AI engine reduces the dynamic power consumption compared to powering separate AI engines. A unified design minimizes the overhead of moving data between AI engines, reducing the energy per computation.

Therefore, combining matrix-matrix (or vector x matrix) and vector-vector operation capabilities in one AI engine using two functional units eliminates the need for separate hardware, thus avoiding silicon waste. This approach maximizes computational density, reduces energy consumption, and enables versatile AI workloads, all while maintaining a smaller chip footprint and reducing overall costs. It is a powerful strategy for next-generation AI accelerators aiming to balance performance, efficiency, and scalability.

Moreover, the AI engine core 210 can be incorporated into a GPU or accelerator unit described below with reference to FIG. 3.

FIG. 3 is a block diagram of an accelerator unit (AU) configured to execute workloads for applications running on a processing system, in accordance with some embodiments.

FIG. 3 presents an AU 300 configured to execute workloads for one or more applications running on a processing system. These applications include, for example, compute applications, graphics applications, or both each configured to issue respective series of instructions, also referred to herein as “threads,” to a central processing unit (CPU) of the processing system. Compute applications, when executed by a processing system, cause the processing system to perform one or more computations, such as machine-learning, neural network, high-performance computing, or databasing computations. Further, graphics applications, when executed by a processing system, cause the processing system to render a scene including one or more graphics objects and, as an example, output the scene on a display. The instructions issued to the CPU from these applications, for example, include groups of threads, also referred to herein as “workgroups,” to be executed by AU 300. To perform these workgroups, AU 300 includes one or more vector processors, coprocessors, graphics processing units (GPUs), general-purpose GPUs, non-scalar processors, highly parallel processors, artificial intelligence (AI) processors, inference engines, AI engines, AI engine cores, machine-learning processors, or any combination thereof. As an example, AU 300 includes one or more command processors 302, front-end circuitry 304, scheduling circuitry 306, compute units 308, shared caches 310, and acceleration circuitry 312. The acceleration circuitry 312 may include first functional circuitry and second functional circuitry for concurrently performing matrix-matrix and vector-vector instructions and/or operations (parallel execution).

A command processor 302 of AU 300 is configured to receive, from the CPU, a command stream indicating one or more workgroups to be executed. As an example, based on a compute application running on the processing system, the command processor 302 receives a command stream indicating workgroups that involve compute operations such as matrix multiplication, addition, subtraction, and the like to be performed. As another example, based on a graphics application running on the processing system, the command processor 302 receives a command stream indicating workgroups that include draw calls for a scene to be rendered. After receiving a command stream, the command processor 302 parses the command stream and issues respective instructions of the indicated workgroups to front-end circuitry 304, scheduling circuitry 306, or both. As an example, based on a command stream from a graphics application, the command processor 302 issues one or more draw calls to front-end circuitry 304 that includes one or more vertex shaders, polygon list builders, and the like. From the instructions issued from the command processor 302, front-end circuitry 304 is configured to position geometry objects in a scene, assemble primitives in a scene, cull primitives, perform visibility passes for primitives in a scene, generate visible primitive lists for a scene, or any combination thereof. For example, based on a set of draw calls received from a command processor 302, front-end circuitry 304 determines a list of primitives to be rendered for a scene. After determining a list of primitives to be rendered for a scene, the front-end circuitry 304 issues one or more draw calls (e.g., a workgroup) associated with the primitives in the list of primitives to scheduling circuitry 306.

Based on the instructions of the workgroups received from a command processor 302, front-end circuitry 304, or both, scheduler circuitry 306 is configured to provide data indicating threads (e.g., operations for these threads) to be executed for these workgroups to one or more compute units 308. Each compute unit 308 is configured to support the concurrent execution of two or more threads of a workgroup. For example, each compute unit 308 is configured to concurrently execute a predetermined number of threads referred to herein as a “wavefront.” Based on the size of the wavefront of a compute unit 308, scheduler circuitry 306 schedules one or more groups of threads of the workgroup, also referred to herein as “waves,” to be executed by the compute unit 308. As an example, scheduler circuitry 306 first updates one or more registers of a compute unit 308 such that the compute unit 308 is configured to execute a first group of waves of the workgroup. After the compute unit 308 has executed the first group of waves, scheduler circuitry 306 updates one or more registers of the compute unit 308 to schedule a second group of waves of the workgroup to be executed by the compute unit 308. To execute these waves, each compute unit is connected to one or more shared caches 310 that each include a volatile memory, non-volatile memory, or both accessible by one or more compute units 308. These shared caches 310, for example, are configured to store data (e.g., register files, values, operands, instructions, variables) used in the execution of one or more waves, data resulting from the performance of one or more waves, or both. Because a shared cache 310 is accessible by two or more compute units 308, a first compute unit 308 is enabled to provide results from the execution of a first wave to a second compute unit 308 executing a second wave. Though the example embodiment presented in FIG. 3 shows AU 300 as including 32 compute units (308-1 to 308-32), in other implementations, AU 300 can include any number of compute units 308.

Each compute unit 308 includes one or more single instruction, multiple data (SIMD) units 314, a scalar unit 316, vector registers 318, scalar registers 320, local data share 322, instruction cache 324, data cache 326, texture filter units 328, texture mapping units 330, or any combination thereof. A SIMD unit 314 (e.g., a vector processor) is configured to concurrently perform multiple instances of the same operation for a wave. For example, a SIMD unit 314 includes two or more lanes each including an arithmetic logic unit (ALU) and each configured to perform the same operation for the threads of a wave. Though the example embodiment presented in FIG. 3 shows a compute unit 308 including three SIMD units (314-1, 314-2, 314-N) representing an N number of SIMD units, in other implementations, a compute unit 308 can include any number of SIMD units 314. Further, as an example, the size of a wavefront supported by AU 300 is based on the number of SIMD units 314 included in each compute unit 308. To determine the operations performed by the SIMD units 314, each compute unit 308 includes vector registers 318 formed from one or more physical registers of AU 300. These vector registers 318 are configured to store data (e.g., operands, values) used by the respective lanes of the SIMD units 314 to perform a corresponding operation for the wave. Additionally, each compute unit 308 includes a scalar unit 316 configured to perform scalar operations for the wave. As an example, the scalar unit 316 includes an ALU configured to perform scalar operations. To support the scalar unit 316, each compute unit 308 includes scalar registers 320 formed from one or more physical registers of the AU 300. These scalar registers 320 store data (e.g., operands, values) used by the scalar unit 316 to perform a corresponding scalar operation for the wave.

Further, each compute unit 308 includes a local data share 322 formed from a volatile memory (e.g., random-access memory) accessible by each SIMD unit 314 and the scalar unit 316 of the compute unit 308. That is to say, the local data share 322 is shared across each wave concurrently executing on the compute unit 308. The local data share 322 is configured to store data resulting from the execution of one or more operations for one or more waves, data (e.g., register files, values, operands, instructions, variables) used in the execution of one or operations for one or more waves, or both. As an example, the local data share 322 is used as a scratch memory to store results necessary for, aiding in, or helpful for the performance of one or more operations by one or more SIMD units 314. The instruction cache 324 of a compute unit 308, for example, includes a volatile memory, non-volatile memory, or both configured to store the instructions to be executed for one or more waves to be executed by the compute unit 308. Further, the data cache 326 of a compute unit 308 includes a volatile memory, non-volatile memory, or both configured to store data (e.g., register files, values, operands, variables) used in the execution of one or more waves by the compute unit 308. The instruction cache 324, data cache 326, shared caches 310, and a system memory, for example, are arranged in a hierarchy based on the respective sizes of the caches. As an example, based on such a cache hierarchy, a compute unit 308 first requests data from a controller of a corresponding data cache 326. Based on the data not being in the data cache 326, the data cache 326 requests the data from a shared cache 310 at the next level of the cache hierarchy. The caches then continue in this way until the data is found in a cache or requested from the system memory, at which point, the data is returned to the compute unit 308. Additionally, each compute unit 308 includes one or more texture mapping units 330 each including circuitry configured to map textures to one or more graphics objects (e.g., groups of primitives) generated by the compute units 308. Further, each compute unit 308 includes one or more texture filter units 328 each having circuitry configured to filter the textures applied to the generated graphics objects. For example, the texture filter units 328 are configured to perform one or more magnification operations, anti-aliasing operations, or both to filter a texture.

Additionally, to help perform instructions for one or more workgroups, AU 300 includes acceleration circuitry 312. Such acceleration circuitry 312 includes hardware (e.g., fixed-function hardware) configured to execute one or more instructions for one or more workgroups. As an example, acceleration circuitry 312 includes one or more instances of fixed function hardware configured to encode frames, encode audio, decode frames, decode audio, display frames, output audio, perform matrix multiplication, or any combination thereof. To schedule instructions for execution on such hardware, scheduling circuitry 306 is configured to update one or more physical registers 332 of AU 300 associated with the hardware. In some cases, AU 300 includes one or more compute units 308 grouped into one or more shader engines 334. Referring to the embodiment presented in FIG. 3, for example, AU 300 includes compute units 308-1 to 308-16 grouped in a first shader engine 334-1 and compute units 308-17 to 308-32 grouped in a second shader engine 334-2. Such shader engines 334, for example, are configured to execute one or more workgroups (e.g., one or more compute kernels) for an application and include one or more compute units 308, graphics processing hardware (e.g., primitive assemblers, rasterizers), one or more shared caches 310, render backends, or any combination thereof. Though the embodiment presented in FIG. 3 shows AU 300 as including two shader engines (334-1, 334-2), in other implementations, AU 300 can include any number of shader engines (334-1, 334-2).

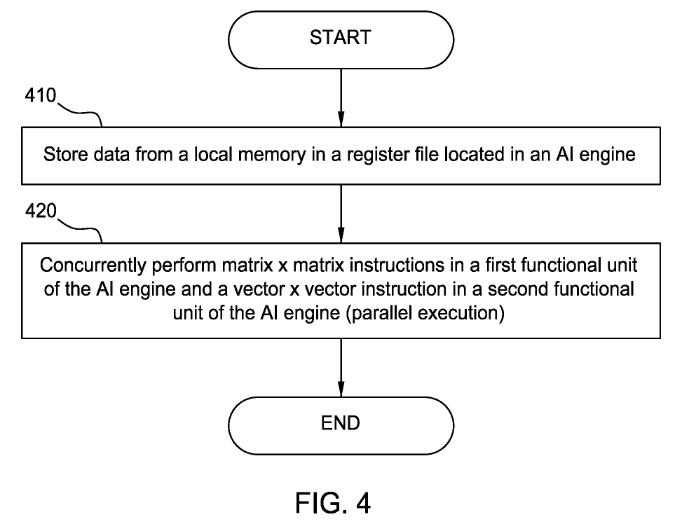

FIG. 4 illustrates a method for using two functional units for concurrently performing matrix x matrix (or matrix x vector) and vector x vector operations, according to an example.

At 410, data from a local memory is stored in a register file located in an AI engine. The AI engine core is optimized for various AI workloads, including ML, DL, and data inference. The AI engine core accelerates the execution of AI algorithms, particularly those involving large-scale data processing and complex mathematical computations, such as matrix multiplications, vector-matrix multiplications, and vector operations.

At 420, matrix x matrix instructions (or vector x matrix) in a first functional unit of the AI engine and vector x vector instruction in a second functional unit of the AI engine are performed concurrently (parallel execution). Incorporating two distinct functional units (the first functional unit and the second functional unit) within the AI engine core, where one is dedicated to matrix × matrix operations (or vector x matrix operations) and the other to vector × vector operations, provides a versatile and efficient computational resource for diverse workloads. This dual-functional-unit architecture allows the AI engine to simultaneously process tasks employed for each operation type, significantly boosting throughput and reducing idle time compared to conventional architectures.

Performing matrix x matrix (or vector x matrix) and vector x vector instructions in parallel using an AI engine core offers several significant benefits, particularly for AI and ML applications. These advantages include at least increased throughput, reduced latency, enhanced performance for complex workloads, flexibility and adaptability, improved energy efficiency, and simplified design and integration.

By executing matrix, vector, and/or vector-matrix operations in parallel, the AI engine core can significantly increase overall throughput. This means that more calculations can be completed in a given time frame, which is beneficial for handling large datasets and complex models in AI applications. Utilizing the AI engine core for both types of operations allows for better utilization of its computational resources. The core can effectively balance workloads, ensuring that matrix, vector, and/or vector-matrix operations do not remain idle while the others are being processed.

Parallel execution minimizes the time taken to complete matrix and vector operations (or vector-matrix operations). This reduction in latency is particularly beneficial for real-time applications, such as interactive AI systems, where quick decision-making is beneficial. Performing operations in parallel can streamline data access patterns, allowing for faster retrieval and processing of intermediate results. This efficiency contributes to overall system responsiveness.

Many AI algorithms, such as DL and neural networks, involve a combination of matrix and vector operations. Performing these operations in parallel allows for smoother implementation of complex algorithms, enabling more effective training and inference processes. Parallel execution of both types of operations supports advanced techniques such as batch processing, where multiple inputs can be processed simultaneously.

An AI engine core capable of parallel execution can dynamically allocate resources based on the specific demands of the workload. This adaptability allows for optimization of performance across different tasks and applications, whether in training, inference, or other AI-related computations. As AI workloads grow in complexity, the ability to perform matrix and vector (and vector-matrix) operations in parallel supports scalable architectures that can accommodate larger models and more extensive datasets without significant performance degradation.

By optimizing resource usage and minimizing the time needed for computations, parallel execution can lead to reduced energy consumption. This is important in edge devices and mobile applications, where energy efficiency is critical. Performing operations in parallel can help distribute the computational load more evenly across the AI engine core, potentially lowering the heat generated during processing. This can enhance system longevity and reduce cooling requirements. By allowing both matrix and vector operations to be processed in parallel within a single AI engine core, the overall system design can be simplified. This integration reduces the need for multiple separate processing units and streamlines the architecture.

In conclusion, the examples enable an AI engine to concurrently or simultaneously perform, using a first functional unit and a second functional unit, matrix x matrix operations (or vector x matrix operations) and vector x vector operations in every cycle. By utilizing an AI engine core that performs matrix x matrix (or vector x matrix) and vector x vector instructions concurrently or simultaneously, using two functional units, significant improvements can be achieved in terms of parallelism, resource optimization, and reduced latency. This approach allows for optimizations tailored to each operation type, ensuring that the AI engine can efficiently handle complex workflows that combine both matrix and vector computations. Consequently, such a design not only enhances the throughput and responsiveness of AI applications but also provides a modular approach to system integration, facilitating the development of scalable and versatile AI solutions.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the "C" programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. An artificial intelligence (AI) engine comprising:
first functional circuitry configured to perform a first set of instructions that include a matrix operation; and
second functional circuitry configured to perform a second set of instructions that include a vector operation, wherein the second set of instructions are concurrently performed with the first set of instructions.

2. The AI engine of claim 1, wherein the first set of instructions include instructions for an operation to perform based on two or more matrices and the second set of instructions include instructions for an operation to perform based on one or more vectors.

3. The AI engine of claim 1, wherein the first set of instructions include instructions for an operation to perform based on a matrix and a vector and the second set of instructions include instructions for an operation to perform based on one or more vectors.

4. The AI engine of claim 1, wherein data corresponding to the first instructions have a first bit length and data corresponding to the second instructions have a second bit length, the second bit length being greater than the first bit length.

5. The AI engine of claim 1, wherein the first functional circuitry performs low-precision arithmetic operations and the second functional circuitry performs higher bit-width precision arithmetic operations.

6. The AI engine of claim 1, wherein the AI engine includes a register file configured to store data read from a local memory.

7. The AI engine of claim 1, wherein the first functional circuitry includes general matrix multiply (GEMM) units and the second functional circuitry includes at least one of arithmetic units, multiply-accumulate units, load-store-units, shuffling and permutation units, reduction units conversion units, comparison units, bitwise logic units, vector condition control units, or vector streaming units.

8. A method comprising:
performing a first set of instructions using first functional circuitry, wherein performing the first set of instructions comprises performing a matrix operation; and
performing a second set of instructions using second functional circuitry, wherein performing the second set of instructions comprises performing a vector operation, and wherein the second set of instructions are concurrently performed with the first set of instructions in an artificial intelligence (AI) engine.

9. The method of claim 8, wherein the first set of instructions include instructions for an operation to perform based on two or more matrices and the second set of instructions include instructions for an operation to perform based on one or more vectors.

10. The method of claim 9, wherein the first set of instructions include instructions for an operation to perform based on a matrix and a vector and the second set of instructions include instructions for an operation to perform based on one or more vectors.

11. The method of claim 8, wherein data corresponding to the first instructions have a first bit length and data corresponding to the second instructions have a second bit length, the second bit length being greater than the first bit length.

12. The method of claim 8, wherein the first functional circuitry performs low-precision arithmetic operations and the second functional circuitry performs higher bit-width precision arithmetic operations.

13. The method of claim 8, wherein the AI engine includes a register file configured to store data read from a local memory.

14. The method of claim 8, wherein the first functional circuitry includes general matrix multiply (GEMM) units and the second functional circuitry includes at least one of arithmetic units, multiply-accumulate units, load-store-units, shuffling and permutation units, reduction units conversion units, comparison units, bitwise logic units, vector condition control units, or vector streaming units.

15. A processor comprising:
one or more artificial intelligence (AI) engines, each AI engine configured to include:
first functional circuitry configured to perform a first set of instructions that include a matrix operation; and
second functional circuitry configured to perform a second set of instructions that include a vector operation, wherein the second set of instructions are concurrently performed with the first set of instructions.

16. The processor of claim 15, wherein the processor is a graphics processing unit (GPU).

17. The processor of claim 15, wherein the first set of instructions include instructions for an operation to perform based on two or more matrices and the second set of instructions include instructions for an operation to perform based on one or more vectors.

18. The processor of claim 17, wherein the first set of instructions include instructions for an operation to perform based on a matrix and a vector and the second set of instructions include instructions for an operation to perform based on one or more vectors.

19. The processor of claim 15, wherein data corresponding to the first instructions have a first bit length and data corresponding to the second instructions have a second bit length, the second bit length being greater than the first bit length.

20. The processor of claim 15, wherein the first functional circuitry performs low-precision arithmetic operations and the second functional circuitry performs higher bit-width precision arithmetic operations.
